(19) United States
(12) Patent Application Publication
(10) Pub. No.: US 2026/0356271 A1
(43) Pub. Date: Nov. 12, 2026

(54) TRUCK TRAILER ENHANCEMENT SYSTEM

(71) Applicant: Bennie Hamilton, Rialto, CA (US)

(72) Inventor: Bennie Hamilton, Rialto, CA (US)

(21) Appl. No.: 19/202,344

(22) Filed: May 8, 2025

(51) Int. Cl. B60P 1/38

(52) U.S. Cl. CPC B60P 1/38

(57) ABSTRACT

A truck trailer enhancement system to be used within a truck trailer, the truck trailer enhancement system including a wall portion disposed on a wall of the truck trailer, a floor portion to be disposed on a floor of the truck trailer, the floor portion including a plurality of rotating tubes to rotate in a first rotational direction or a second rotational direction, and a movable floor wrapped around the plurality of rotating tubes to move in a first direction in response to the plurality of rotating tubes rotating in the first rotational direction, and to move in a second direction in response to the plurality of rotating tubes rotating in the second rotational direction, and a control panel to control a rotational movement of the plurality of rotating tubes based on a user's preference.

### BACKGROUND

### 1. Field

The present general inventive concept relates generally to a truck trailer, and particularly, to a truck trailer enhancement system.

### 2. Description of the Related Art

Trucks and trailers are commonly used around to world to transport various types of cargo.

However, loading and unloading trucks and trailers can prove to be difficult, especially if a driver has an injury or handicap.

Therefore, there is a need for a system that facilitates loading and unloading of cargo within a truck or trailer.

### SUMMARY

The present general inventive concept provides a truck trailer enhancement system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a truck trailer enhancement system to be used within a truck trailer, the truck trailer enhancement system including a wall portion disposed on a wall of the truck trailer, a floor portion to be disposed on a floor of the truck trailer, the floor portion including a plurality of rotating tubes to rotate in a first rotational direction or a second rotational direction, and a movable floor wrapped around the plurality of rotating tubes to move in a first direction in response to the plurality of rotating tubes rotating in the first rotational direction, and to move in a second direction in response to the plurality of rotating tubes rotating in the second rotational direction, and a control panel to control a rotational movement of the plurality of rotating tubes based on a user's preference.

The truck trailer enhancement system may further include an extendable mechanical arm disposed along the floor portion to extend and/or contract based on a user's preference.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front and left side angled perspective view of a truck trailer enhancement system, according to an exemplary embodiment of the present general inventive concept; and

FIG. 2 illustrates a front and left side angled perspective view of the truck trailer enhancement system of FIG. 1 installed within a truck trailer, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### List of Components

Truck Trailer 10
Remote Control 20
Truck Trailer Enhancement System 100
Wall Portion 110
Wall 111
Straps112
Latches 113
Motorized Arm 114
Floor Portion 120
Rotating Tubes 121
Movable Floor 122
Cargo Stabilizing Grooves 123
Extendable Mechanical Arm 130
Control Panel 140
Forward Button 141
Reverse Button 142
Stop Button 143
Doors 150
Door Rails 151
Door Rail Grooves 152
Door Locking Pipes 153
Locking Pipe Receiving Members 160

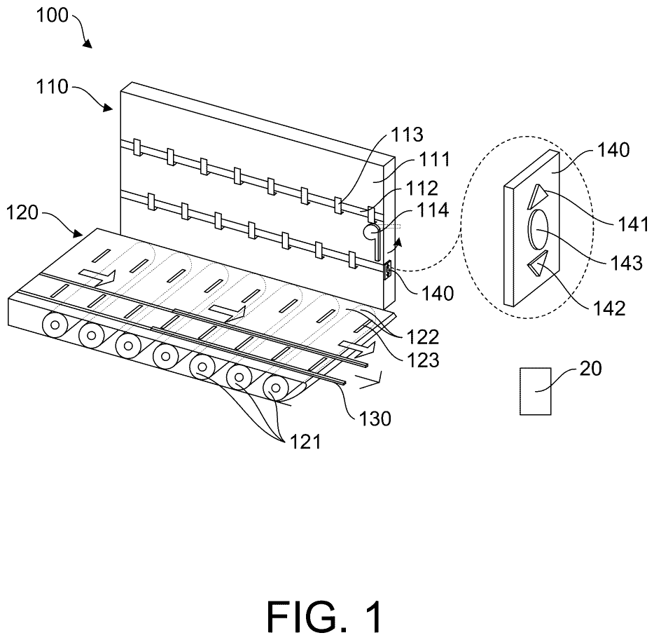

FIG. 1 illustrates a front and left side angled perspective view of a truck trailer enhancement system 100, according to an exemplary embodiment of the present general inventive concept.

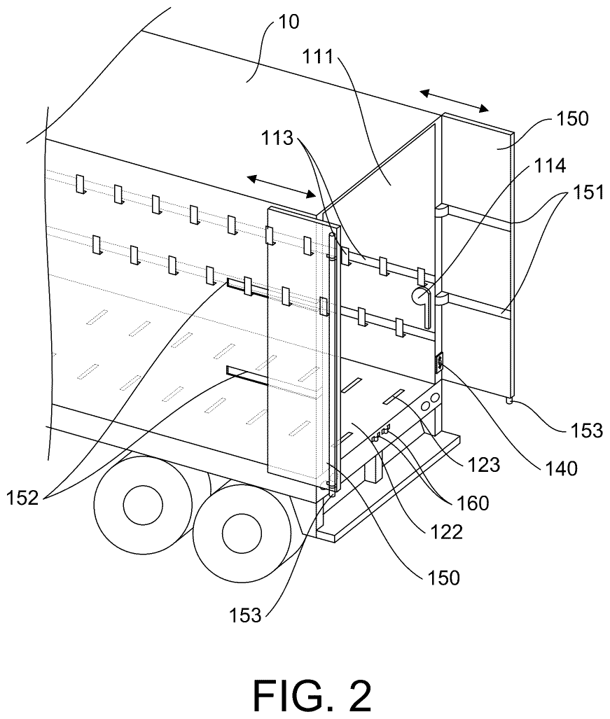

FIG. 2 illustrates a front and left side angled perspective view of the truck trailer enhancement system 100 of FIG. 1 installed within a truck trailer 10, according to an exemplary embodiment of the present general inventive concept.

The truck trailer enhancement system 100, and all components therein, may be constructed from at least one of wood, plastic, paper, metal, silicone, liquid, fibers, threads, fabric, foam, sponge, nylon, vinyl, feathers, glass, adhesives, circuitry, and rubber, etc., but is not limited thereto, and can be constructed from any material known to one of ordinary skill in the art.

The truck trailer enhancement system 100 may include a wall portion 110, a floor portion 120, an extendable mechanical arm 130, a control panel 140, a plurality of doors 150, and a plurality of locking pipe receiving members 160, but is not limited thereto.

The truck trailer enhancement system 100 may be designed to be installed onto and/or within any type of conventional truck trailer 10 known to one of ordinary skill in the art, or alternatively, the truck trailer 10 may be manufactured to include the truck trailer enhancement system 100 therewithin.

A remote control 20 may be provided to communicate with any and all components within the truck trailer 10 and/or the truck trailer enhancement system 100.

The wall portion 110 may include a wall 111, a plurality of straps 112, a plurality of latches 113, and a motorized arm 114, but is not limited thereto.

The wall 111 may be configured to be any inner wall of the truck trailer 10.

The plurality of straps 112 and the plurality of latches 113 may be used to secure cargo against the wall 111.

The motorized arm 114 may be configured to facilitate securing and/or movement of cargo within the truck trailer 10.

The floor portion 120 may include a plurality of rotating tubes 121, a movable floor 122, and a plurality of cargo stabilizing grooves 123, but is not limited thereto.

The extendable mechanical arm 130 may be disposed on or over the movable floor 122, and may be controlled by the remote control 20 to extend and/or retract based on a user's preference. in order to allow cargo placed onto the extendable mechanical arm 130 to more easily be loaded into an inner portion of the truck trailer 10.

The control panel 140 may be installed onto any part of the truck trailer 10 and/or the truck trailer enhancement system 100, and may be electronically connected to any/all of the components within the truck trailer enhancement system 100 and/or the truck trailer 10,

The control panel 140 may include a forward button 141 to control the plurality of rotating tubes 121 to rotate in a first rotating direction to cause the movable floor 122 to move in a first direction in order to allow cargo placed on the movable floor 122 to move from a rear portion of the truck trailer 10 to a front portion of the truck trailer 10, a reverse button 142 to control the plurality of rotating tubes 121 to rotate in a second rotating direction to cause the movable floor 122 to move in a second direction in order to allow cargo placed on the movable floor 122 to move from the front portion of the truck trailer 10 to the rear portion of the truck trailer 10, and a stop button 143 to stop movements of the rotating tubes 121 and the movable floor 122.

The plurality of doors 150 may be installed at the rear portion of the truck trailer 10, and may include door rails 151, and door locking pipes 153, but is not limited thereto.

The truck trailer 10 may include, at side rear outer wall portions thereof, a plurality of door rail grooves 152 to receive the door rails 151 therein when the plurality of doors 150 are open to allow the plurality of doors 150 to slide along the plurality of door rail grooves 152.

The door locking pipes 153 may be disposed within edge portions of the plurality of doors 150, and may be controllable by the remote control 20 to protrude out bottom portions of the plurality of doors 150 in order to enter into the locking pipe receiving members 160, which are disposed at rear portions of the truck trailer 10, to allow the plurality of doors 150 to lock, based on a user's preference.

The present general inventive concept may include a truck trailer enhancement system 100 to be used within a truck trailer 10, the truck trailer enhancement system 100 including a wall portion 110 disposed on a wall of the truck trailer 10, a floor portion 120 to be disposed on a floor of the truck trailer 10, the floor portion 120 including a plurality of rotating tubes 121 to rotate in a first rotational direction or a second rotational direction, and a movable floor 122 wrapped around the plurality of rotating tubes 121 to move in a first direction in response to the plurality of rotating tubes 121 rotating in the first rotational direction, and to move in a second direction in response to the plurality of rotating tubes 121 rotating in the second rotational direction, and a control panel 140 to control a rotational movement of the plurality of rotating tubes 121 based on a user's preference.

The truck trailer enhancement system 100 may further include an extendable mechanical arm 130 disposed along the floor portion 120 to extend and/or contract based on a user's preference.

A main purpose of the present general inventive concept is to simplify and automate the process of loading and unloading cargo, especially for individuals with disabilities, mobility challenges, or anyone who finds manual labor strenuous. It is designed to reduce physical strain during the loading and unloading process, making it easier for users to move cargo into and out of the trailer. By incorporating motorized systems, the present general inventive concept increases the efficiency of cargo movement, ultimately saving time and reducing labor costs. Additionally, it enhances the safety of both users and cargo, with security features like smart locks and two-way communication. Overall, it provides an accessible and convenient solution for people who face challenges with manual loading tasks, while offering a more efficient way to transport goods. The present general inventive concept includes several key components that work together to automate and simplify the cargo loading process. The wall provides structural support and ensures that the cargo stays securely in place during transit. Latches and straps help fasten and restrict the cargo, preventing it from shifting while the trailer is in motion. The motorized moving floor is the core of the trailer's automation system; it functions like a conveyor belt, moving cargo into the trailer with minimal physical effort required from the user. The motorized cargo stabilizer ensures that once cargo is inside the trailer, it remains stable and does not shift during transport. For heavier or awkwardly shaped items, the motorized arm can be used to move and position the cargo with precision, reducing the need for manual lifting. The tracks for sliding doors and door sliding mechanism work together to provide easy access to the trailer, allowing the doors to open and close smoothly. To enhance security, the trailer features smart locks that can be controlled remotely via a dashboard or mobile app, ensuring only authorized access to the cargo. The present general inventive concept addresses several common challenges associated with loading and unloading cargo. For individuals with physical limitations, such as those with disabilities or mobility issues, loading cargo can be both physically demanding and painful. The motorized systems in the present general inventive concept—like the moving floor, stabilizer, and motorized arm—significantly reduce the physical effort required, making the process easier and less strenuous. Traditional loading methods are often time-consuming and involve heavy lifting, but the Super Trailer speeds up the process with its automated systems, reducing the time spent loading and unloading. Another major issue in traditional cargo transportation is cargo shifting during transit. Without proper securing mechanisms, items can move, potentially causing damage. The present general inventive concept solves this problem with latches, straps, and a cargo stabilizer to keep items firmly in place. Security is also a concern in many trailers, especially with valuable or sensitive cargo. The present general inventive concept addresses this with smart locks, a remote control system, and two-way cameras, allowing users to monitor and control access to the trailer securely.

Lastly, the present general inventive concept provides a solution for people with limited mobility by making loading and unloading tasks more accessible and reducing the need for manual labor. Its automated systems make it much easier to handle bulky or heavy items, minimizing the risk of injury or strain. The present general inventive concept is an innovative solution that combines automation and advanced features to address the difficulties of loading and unloading cargo. By reducing the physical effort required, improving the speed of the process, and enhancing the security of the trailer, it makes cargo transportation safer, more efficient, and more accessible. It is especially beneficial for individuals with disabilities or limited mobility, but also serves industries that rely on efficient and secure cargo movement. The present general inventive concept not only simplifies the logistical process but also provides a practical and effective solution for a variety of users.

What makes the present general inventive concept unique is its combination of motorized automation and accessibility features designed to simplify the otherwise labor-intensive task of loading and unloading cargo. It integrates a motorized moving floor, stabilizing systems, and a motorized arm to effortlessly move and secure items without manual labor, making it ideal for individuals with disabilities or mobility challenges. Additionally, its smart locks, remote control capabilities, and two-way communication system enhance security and convenience, while the sliding door mechanism ensures easy access. This combination of innovative technology and accessibility makes the present general inventive concept a game-changer in the logistics and transportation industry.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A truck trailer enhancement system to be used within a truck trailer, the truck trailer enhancement system comprising:
a wall portion disposed on a wall of the truck trailer;
a floor portion to be disposed on a floor of the truck trailer, the floor portion comprising:
a plurality of rotating tubes to rotate in a first rotational direction or a second rotational direction, and
a movable floor wrapped around the plurality of rotating tubes to move in a first direction in response to the plurality of rotating tubes rotating in the first rotational direction, and to move in a second direction in response to the plurality of rotating tubes rotating in the second rotational direction; and
a control panel to control a rotational movement of the plurality of rotating tubes based on a user's preference.

2. The truck trailer enhancement system of claim 1, further comprising:
an extendable mechanical arm disposed along the floor portion to extend and/or contract based on a user's preference.
